(19) United States
(12) Patent Application Publication
(10) Pub. No.: US 2005/0163414 A1
(43) Pub. Date: Jul. 28, 2005

(54) Rib structural system and method of manufacturing the rib structural system

(75) Inventors: Hajime Takeya, Tokyo (JP); Tsuyoshi Ozaki, Tokyo (JP); Steven Hahn, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/960,062

(22) Filed: Oct. 8, 2004

(30) Foreign Application Priority Data
Jan. 26, 2004 (JP) 2004-017215

(51) Int. Cl. G02B 6/26; G02B 6/34

(52) U.S. Cl. 385/12; 385/37

(57) ABSTRACT

In a method of manufacturing a rib structural system, tape-shaped prepregs, each made of a fiber reinforced composite material into which a resin is impregnated, are laminated to form ribs in the form of a grid, while an optical fiber including Fiber Bragg Grating members at predetermined locations is layered in the ribs. The Fiber Bragg Grating members are arranged at intermediate locations dependent upon their reflection wavelengths, each of the intermediate locations being substantially midway between two adjacent intersections in of two or more ribs.

### BACKGROUND OF THE INVENTION

1. Field of the Invention

The present invention relates to a rib structural system which can automatically and surely monitor the soundness of a structure, such as an aircraft or a satellite, and which includes a number of fiber sensors layered therein, and a method of manufacturing the rib structural system.

2. Description of Related Art

Conventionally, it is very important for any one of various structures, such as aircrafts and satellites, to be fully equipped with a system capable of always monitoring the soundness thereof from the viewpoint of the insurance of the reliability of the structure, the completion of missions, and so on. A method of sticking a strain gage to a specific location (or point) of a target structure, such as an aircraft, and detecting the amount of strain at the specific location has been well known as a method of monitoring the soundness of the structure. According to the prior art method of detecting the amount of strain at a specific location of a structure by using a strain gage, when the structure is a two-dimensional plane-shaped one, it is necessary to stick a set of three strain gages to the specific location (or point) of the structure, the three strain gages respectively extending in three directions (i.e., the direction of the x-axis of the structure, the direction of the y-axis of the structure, and the direction of shearing). In addition, in order to detect the amount of strain over the whole of a structure, many strain gages (or sensors) have to be respectively arranged at many points arranged in the form of a grid and along many directions, and therefore a large increase in cost and a great deal of time are required for implementing monitoring of the soundness of the structure. When detecting the amount of strain over the whole of a three-dimensional structure, it is structurally difficult or impossible to arrange many strain gages on the structure in most cases and therefore this well-known method is not realistic.

A method of using an FBG (Fiber Bragg Grating) sensor has been known as the method of diagnosing the soundness of a structure. The FBG sensor utilizes a phenomenon in which the center wavelength of a spectrum of reflection from a Fiber Bragg Grating formed in an optical fiber intended for communications changes due to strain and temperature so as to mainly measure the amount of strain from a change in the center wavelength. Since a glass fiber having a very small diameter (for example, a diameter of 125 micrometers) is used for the FBG sensor, the FBG sensor can be easily embedded or attached into or to a laminated structure with CFRP, which is widely used for forming a lightweight structure. It is also possible to form a large-scale sensor network by using the long distance transmission nature of the optical fiber and a wavelength multiplexing technique. In view of these facts, the use of a sensor network including a number of FBG sensors can be assumed to be suitable for diagnosis of the soundness of a large-sized lightweight structure. As such a number of FBG sensors, a plane-shaped sensor using an optical fiber provided with two or more gratings having different pitches is stuck to a structure. The plane-shaped sensor can conform to surfaces of various shapes and can detect the amount of strain and temperature changes at each of two or more points on a surface of the structure (for example, see patent reference 1).
[Patent reference 1] Japanese patent application publication (TOKKAI) No. 2002-71323 (see pages 3 to 4 and FIG. 3)

According to the prior art diagnostic method using the above-mentioned plane-shaped sensor, by carrying out a measurement of how much change in the center wavelength occurs in which one of the plurality of FBG sensors contained in the plane-shaped sensor, locations where strains have occurred and the amounts of strains can be detected. However, only a single FBG sensor is not necessarily influenced by a local strain and a wavelength variation appears as a composition of strains which have occurred in several sensors. Therefore, in order to correctly grasp locations where strains have occurred and the amounts of strains, analyses on the composition of strains which have occurred in several sensors have to be carried out. When FBG sensors are arranged as previously mentioned, the amounts of strains in both the direction of the x-axis and the direction of the y-axis can be detected, whereas the amount of strain in a slanting direction, such as a direction of an angle of 45 degrees with respect to the x-axis and the y-axis, is not detected. Therefore, in order to improve the detection accuracy, the number of sensors which are arranged according to many measurement points and many measurement directions has to be increased while fine analyses have to be performed on data obtained from the plurality of sensors. A problem with the prior art diagnostic method is however that the measurement processing becomes more difficult and the analysis processing becomes more complicated with increase in the number of sensors, and the manufacturing cost increases accordingly.

As previously mentioned, the above-mentioned prior art plane-shaped sensor can conform to surfaces of various shapes and can detect the amount of strain at each of two or more points on a surface of a structure. A problem with the prior art plane-shaped sensor is however that it is difficult or impossible for the prior art plane-shaped sensor to detect the amount of strain on a two-dimensional surface of a structure having a complicated shape or a three-dimensional structure, that is, the prior art plane-shaped sensor has a limited sensor ability.

### SUMMARY OF THE INVENTION

The present invention is made in order to solve the above-mentioned problems with prior art sensors for and prior art diagnostic methods of diagnosing the soundness of a structure, such as an aircraft or a satellite, and it is therefore an object of the present invention to provide a rib structural system which can automatically and surely monitor the soundness of a structure, such as an aircraft, and which includes fiber sensors each having a health monitoring function and layered therein, and a method of manufacturing the rib structural system at a low cost.

In accordance with the present invention, there is provided a rib structural system including: a grid provided with a plurality of ribs; and an optical fiber in which a plurality of Fiber Bragg Grating members having at least two reflection wavelengths are formed, each of the plurality of Fiber Bragg Grating members being located substantially midway between two adjacent intersections of the grid in each of which two or more of the plurality of ribs intersect.

The rib structural system of the present invention provided with the plurality of ribs arranged in the form of a grid and having a health monitoring function can observe strains which occur in a structure at the time of their occurrence by using the plurality of FBG sensors each of which is located substantially midway between two adjacent intersections in each of which two or more of the plurality of ribs intersect. Therefore, the rib structural system can automatically monitor the soundness of a structure, such as an aircraft, with a high degree of reliability.

In addition, since the grid of the rib structural system according to the present invention has a lightweight structure originally and is made of a lightweight material, such as a fiber reinforced composite material, and the rib structural system can carry out health monitoring by using the plurality of FBG sensors, it is possible to perform design of a structure on which the rib structural system according to the present invention is mounted without having to provide a superfluous additional margin of the strength of the structure and the rib structural system can be optimally reduced in weight. Therefore, the rib structural system according to the present invention is suitable for applications to structures intended for an aircraft, a space craft, and so on. The grid structure has a high degree of reliability, and, even if a part of the grid structure breaks, the breakdown will never progress to the whole of the grid at once. In addition, because the rib structural system has a health monitoring function by using the plurality of FBG sensors, as described above, the rib structural system according to the present invention has a high degree of reliability. Since a path of stress or temperature is simple in the grid structure, the grid structure is suitable for monitoring of the soundness of a two-dimensional structure.

A method of manufacturing the rib structural system according to the present invention having a health monitoring function can utilize a filament winding (FW) method or the like capable of automatically and integrally forming prepregs, such as CFRPs, and an optical fiber. Therefore, the method according to the present invention can manufacture a rib structural system of high reliability at a low cost and in a short time, and excels in manufacturability.

Further objects and advantages of the present invention will be apparent from the following description of the preferred embodiments of the invention as illustrated in the accompanying drawings.

### BRIEF DESCRIPTION OF THE DRAWINGS

FIG. 1 is a diagram of a rib structural system in accordance with embodiment 1 of the present invention, in which a plurality of FBG sensors are layered;

FIG. 2 is a cross-sectional view of part of a rib shown in FIG. 1;

FIG. 3 is a diagram showing a method of conducting tests on the rib structural system in accordance with embodiment 1 of the present invention, in which the plurality of FBG sensors are layered;

FIGS. 4A and 4B are diagrams for explaining a first effect of the plurality of FBG sensors according to embodiment 1;

FIGS. 5A and 5B are diagrams for explaining a second effect of the plurality of FBG sensors according to embodiment 1;

FIG. 6 is a diagram showing an example of a tensile test which is conducted on the rib structural system in which the plurality of FBG sensors are layered;

FIG. 7 is a diagram showing an example of a tensile test which is conducted on the rib structural system to which a panel is attached and in which the plurality of FBG sensors are layered;

FIG. 8 is a diagram showing a manufacturing procedure in accordance with embodiment 2 of the present invention for manufacturing a rib structural system;

FIG. 9 is a diagram showing a concrete example of the manufacturing procedure in accordance with embodiment 2 of the present invention;

FIG. 10 is a diagram showing a manufacturing method in accordance with embodiment 3 of the present invention;

FIG. 11 is a diagram of a variant of the rib structural system in accordance with embodiment 1 of the present invention;

FIG. 12 is a diagram of another variant of the rib structural system in accordance with embodiment 1 of the present invention; and

FIG. 13 is a diagram of a further variant of the rib structural system in accordance with embodiment 1 of the present invention.

### DETAILED DESCRIPTION OF THE PREFERRED EMBODIMENTS

### Embodiment 1

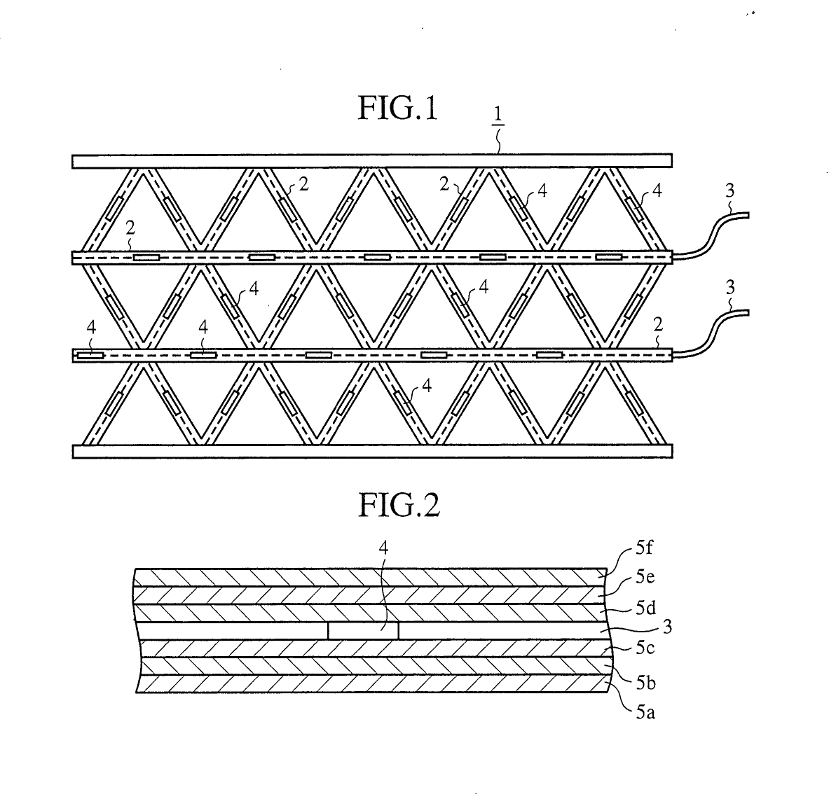

FIG. 1 is a diagram showing a rib structural system 1 according to embodiment 1, the structural system 1 including optical fibers 3 each of which is layered therein and has a plurality of FBG (Fiber Bragg Grating) members. The rib structural system 1 is constructed of a plurality of ribs 2 which are arranged in the form of a grid. Each of the plurality of ribs 2 is a stack of several laminated carbon fiber reinforced plastic layers. A plurality of FBG members 4 (referred to as FBG sensors 4 from here on) are formed in the optical fiber 3. FIG. 1 shows the rib structural system 1 in fluoroscopy, each dotted line denotes an optical fiber which cannot be seen from outside the rib structural system, and each rectangle explicitly indicates the location of an FBG sensor 4. The plurality of FBG sensors 4 have the same outer diameter as the optical fiber 3. The plurality of FBG sensors 4 are so constructed as to have different reflection wavelengths. Each of the plurality of FBG sensors 4 is arranged substantially midway between two adjacent intersections in each of which two or more of the plurality of ribs 2 of the rib structural system 1 intersect, as shown in FIG. 1. Thus, in order to arrange each of the plurality of FBG sensor 4 almost midway between two adjacent intersections in each of which two or more of the plurality of ribs 2 of the rib structural system 1 intersect, the locations in the optical fiber 3 where the plurality of FBG sensors 4 are formed are determined by the size of the rib structural system 1, the spacing between any two adjacent ribs 2, the routing of the optical fiber 3, a margin of the routing, etc. Each of the plurality of FBG sensors 4 is layered in one of the plurality of ribs 2 and is placed at a location dependent upon the reflection wavelength thereof.

FIG. 2 is a longitudinal cross-sectional view of a part of each of the plurality of ribs which is located between two adjacent intersections in each of which two or more of the plurality of ribs 2 of the rib structural system 1 of FIG. 1 intersect. For the sake of simplicity, each of the plurality of ribs 2 consists of six carbon fiber reinforced plastic layers. Each of the plurality of ribs 2 includes six carbon fiber reinforced plastic layers 5 and a part of the optical fiber 3 which is laminated midway between the six carbon fiber reinforced plastic layers.

As shown in FIG. 2, a second carbon fiber reinforced plastic layer 5b is laminated on a first carbon fiber reinforced plastic layer 5a, a third carbon fiber reinforced plastic layer 5c is further laminated on the second carbon fiber reinforced plastic layer 5b, and the optical fiber 3 is further wired (or routed) on the third carbon fiber reinforced plastic layer 5c. At this time, an FBG sensor 4 of the optical fiber 3 is so arranged as to be substantially midway between two adjacent intersections in each of which two or more ribs 2 intersect. Furthermore, fourth through sixth carbon fiber reinforced plastic layers 5d, 5e, and 5f are laminated on the optical fiber 3.

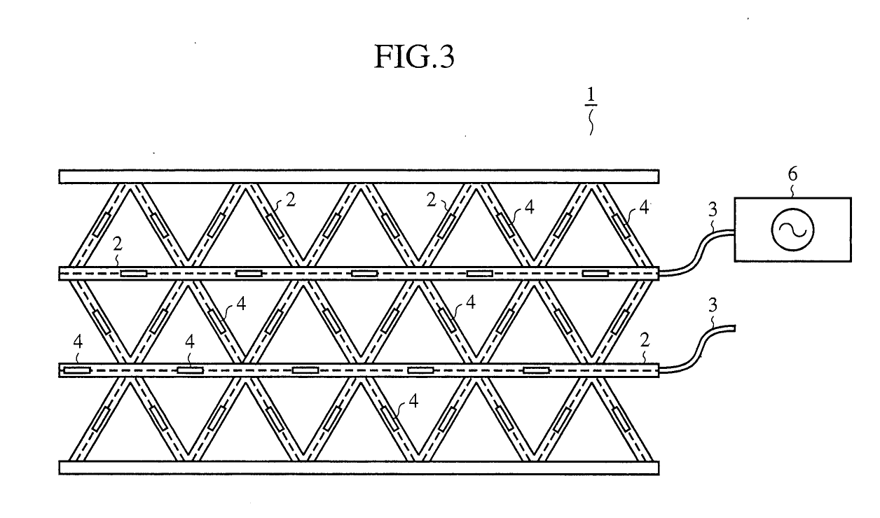

A diagnostic apparatus 6 connected to an end of the optical fiber 3, which is extending to outside the rib structural system 1, as shown in FIG. 3, can diagnose which parts of the rib structural system 1 have which amounts of strains, respectively. The diagnostic apparatus 6 is provided with a light source for launching light into the end of the optical fiber 3, an optical spectrum analyzer for measuring the wavelengths of rays of light reflected by the plurality of FBG sensors 4 each for reflecting the light incident upon the optical fiber 3, a device for calculating the amount of strain at each of the plurality of FBG sensors 4 from a difference between the center wavelength of the incident light and the center wavelength of light reflected by each of the plurality of FBG sensors 4, and so on.

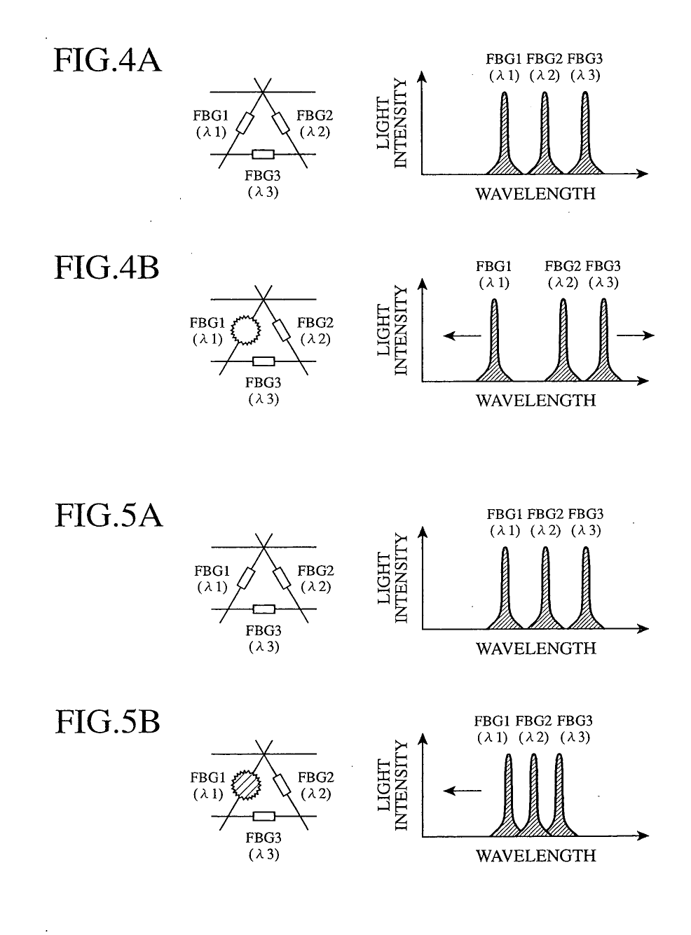

FIGS. 4A, 4B, 5A, and 5B are diagrams showing how a center wavelength shift occurs when a strain occurs in the rib structural system 1. FIGS. 4A and 4B show a center wavelength shift that occurs when one of the plurality of ribs 2 becomes damaged, and FIGS. 5A and 5B show a center wavelength shift that occurs when exfoliation occurs between layers of a panel attached to the rib structural system or between the rib structural system and the panel.

FIG. 4A shows a spectrum of three rays of light respectively reflected by three FBG sensors 4 (FBG1, FBG2, and FBG3) contained in a part of the rib structural system 1 when the rib structural system 1 is placed in a normal state, the three FBG sensors 4 having their respective center wavelengths of λ1, λ2, and λ3. When a rib containing the first sensor FBG1 becomes damaged, the center wavelength λ1 of the reflected light from the first sensor FBG1 shifts to a lower one due to compression applied to the rib, as shown in FIG. 4B, while the center wavelengths λ2 and λ3 of the reflected rays of light from the two other sensors FBG2 and FBG3 to higher ones because a tension appears in each of the two ribs respectively containing the two other sensors FBG2 and FBG3 and supporting the damaged rib.

FIGS. 5A and 5B show a center wavelength shift that occurs when exfoliation occurs between layers of a panel attached to the rib structural system 1 or between the rib structural system and the panel. In the figures, assuming that three rays of light reflected by the three sensors FBG1, FBG2, and FBG3 have respective center wavelengths of λ1, λ2, and λ3, when exfoliation occurs between a rib containing the first sensor FBG1 layered therein and the panel or when exfoliation occurs between layers of the panel (in the case of FIG. 5B), all the center wavelengths of λ1, λ2, and λ3 of the reflected rays of light shit to lower ones due to compression applied to the rib.

Thus, when a part of a structure, such as an aircraft or an artificial satellite, to which the rib structural system is attached, becomes damaged, a strain that occurs in a rib located in the vicinity of the damaged part surely changes from the one that existed in the rib before the part of the structure has become damaged. This change is observed as a shift of the center wavelength of light reflected by an FBG sensor which is located substantially midway between two adjacent intersections where two or more other ribs adjacent to the above-mentioned rib intersect. Therefore, the grid-shaped rib structural system 1 in which the plurality of FBG sensors 4 are layered can carry out diagnoses of the soundness of the structure, such as whether or not the structure is healthy, whether the structure has become damaged, and which part of the structure has become damaged, with a high degree of accuracy, by launching light emitted out of the light source into one end of the optical fiber 3, and then monitoring a shift of the center wavelength of light reflected from each of the plurality of FBG sensors 4. In the above-mentioned example, the plurality of FBG sensors, which are layered in the plurality of ribs, have different reflection wavelengths. As an alternative, the plurality of FBG sensors can include two or more FBG sensors having the same reflection wavelength if each of the two or more FBG sensors has two or more reflection wavelengths. This variant makes it possible to grasp such a tendency as a gradient of changes in a strain which has occurred in the structure by observing changes in the center wavelengths of rays of light reflected from the two or more FBG sensors having the same reflection wavelength, and to determine the direction of the strain by observing reflected rays of light having other center wavelengths.

Since a shift of the center wavelength of light reflected from each FBG sensor can also occur due to variations in the temperature of the structure, when a temperature change occurs in a location of the structure, it is possible to specify the location of the structure and to detect the temperature change by detecting a corresponding variation in the center wavelength of light reflected from each FBG sensor. Therefore, the rib structural system of this embodiment makes it possible to quickly inform the occurrence of an abnormality in either the structure or other equipment located in the vicinity of the structure which has resulted in the temperature change, and therefore makes it possible for operators or users to take required measures against the occurrence of the abnormality in either the structure or the other equipment.

Next, concrete examples of this embodiment will be explained.

### EXAMPLE 1

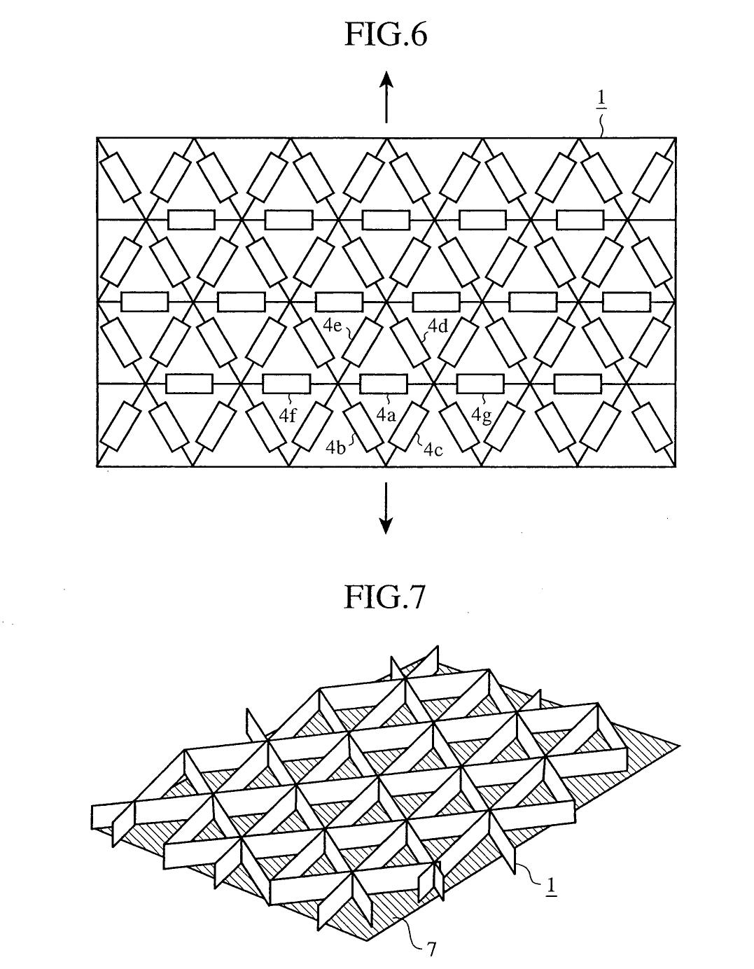

FIG. 6 is a diagram schematically showing only the optical fiber 3 which is layered in the rib structural system 1 shown in FIG. 1, the optical fiber 3 including the plurality of FBG sensors 4. In this figure, the plurality of ribs 2 are not illustrated. A tensile test was conducted in such a manner that tensions in directions indicated by arrows were applied to both the longitudinal sides of the rib structural system and the rib structural system was partially destroyed. An ASE (Amplified Spontaneous Emission) light source having a 1.55-micrometer band and an optical spectrum analyzer were used for the tensile test. Then, the center wavelengths of rays of light reflected from five FBG sensors 4 were observed. The center wavelengths of rays of light reflected from the five FBG sensors 4a to 4e shown in FIG. 6 were measured as mentioned below.

a) Before the tensions in the directions indicated by the arrows were applied to the rib structural system, the center wavelengths were measured as follows:

the center wavelength of light reflected from the FBG sensor 4a=1,548 nm; the center wavelength of light reflected from the FBG sensor 4b=1,550 nm; the center wavelength of light reflected from the FBG sensor 4c=1,552 nm; the center wavelength of light reflected from the FBG sensor 4d=1,554 nm; and the center wavelength of light reflected from the FBG sensor 4e=1,556 nm.

b) After the tensions in the directions indicated by the arrows were applied to the rib structural system, the center wavelengths were measured as follows:

No reflected light from the FBG sensor 4a; the center wavelength of light reflected from the FBG sensor 4b=1,550.8 nm; the center wavelength of light reflected from the FBG sensor 4c=1,552.8 nm; the center wavelength of light reflected from the FBG sensor 4d=1,554.8 nm; and the center wavelength of light reflected from the FBG sensor 4e=1,556.8 nm.

The above-mentioned test results show that a rib having the FBG sensor 4a layered therein was broken and other ribs surrounding the rib supported the rib.

### EXAMPLE 2

FIG. 7 shows the rib structural system 1 equipped with a plane panel 7 attached thereto. A tensile test was conducted on the rib structural system 1 shown in FIG. 7, as in the case of above-mentioned example 1. Although the optical fiber, which is layered in the rib structural system 1, and the plurality of FBG sensors 4 are not illustrated, the rib structural system 1 has these components, as shown in FIG. 6. In this example, seven FBG sensors 4a to 4g are targets to be observed. In this tensile test, a tension was applied to the rib structural system 1 until exfoliation occurs between one or more ribs and the panel.

The center wavelengths of rays of light reflected from the seven FBG sensors 4a to 4g were measured as mentioned below.

a) Before the tensions in the directions indicated by the arrows were applied to the rib structural system, the center wavelengths were measured as follows:

the center wavelength of light reflected from the FBG sensor 4a=1,545 nm; the center wavelength of light reflected from the FBG sensor 4b=1,548 nm; the center wavelength of light reflected from the FBG sensor 4c=1,550 nm; the center wavelength of light reflected from FBG sensor 4d=1,552 nm; the center wavelength of light reflected from the FBG sensor 4e=1,554 nm; the center wavelength of light reflected from the FBG sensor 4f=1,556 nm; and the center wavelength of light reflected from the FBG sensor 4g=1,558 nm

b) After the tensions in the directions indicated by the arrows were applied to the rib structural system, the center wavelengths were measured as follows:

the center wavelength of light reflected from the FBG sensor 4a=1,545.2 nm; the center wavelength of light reflected from the FBG sensor 4b=1,548.7 nm; the center wavelength of light reflected from the FBG sensor 4c=1,550.7 nm; the center wavelength of light reflected from the FBG sensor 4d=1,552.7 nm; the center wavelength of light reflected from the FBG sensor 4e=1,554.7 nm; the center wavelength of light reflected from the FBG sensor 4f=1,556.8 nm; and the center wavelength of light reflected from the FBG sensor 4g=1,558.8 nm.

This result shows that the amount of change in the center wavelength of light reflected from the FBG sensor 4a was small. This means that when the whole of the rib structural system extended due to tension applied thereto during the tensile test, part of the panel in the vicinity of a rib in which the FBG sensor 4a is layered became damaged and the balance between the ribs and the panel which supported the stress in cooperation with each other was varied, and therefore the panel mainly supported the stress and part of the stress applied to the rib in which the FBG sensor 4a is layered was reduced. It is thus detectable that part of the panel in the vicinity of the rib which the FBG sensor 4a is layered became damaged.

As mentioned above, according to this embodiment, the grid-shaped rib structural system has a plurality of triangular units, as shown in FIG. 1, which are continuously arranged. As an alternative, the grid-shaped rib structural system can have a plurality of any polygonal units which only have to be repeatedly and continuously arranged, such as quadrangular units or hexagonal units, other than triangular units.

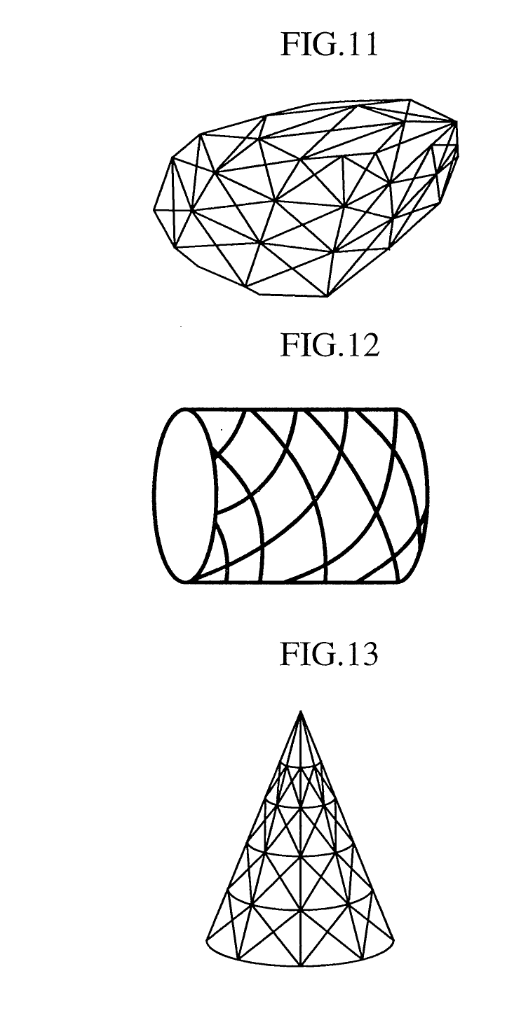

The rib structural system according to this embodiment is the two-dimensional plane-shaped one or the one equipped with a plane panel attached thereto, as mentioned above. As an alternative, the rib structural system according to this embodiment can be the shell-shaped one (see FIG. 11) having a thin three-dimensional curved portion, the cylindrical one (see FIG. 12), or the conic one (see FIG. 13). The rib structural system according to any one of these variants can include an optical fiber including a plurality of FBG members which is layered in the plurality of ribs.

As mentioned above, according to this embodiment 1, each of the plurality of ribs is made of carbon fiber reinforced plastic. As alternative, each of the plurality of ribs can be made of a composite material reinforced with a glass fiber or a Keplar fiber. Each of the plurality of ribs can be alternatively made of a lightweight fiber reinforced composite material, such as C/C (i.e., carbon fiber reinforced carbon) or C/Sic (carbon fiber reinforced silicon carbide), or a lightweight metallic material such as aluminum or an aluminum alloy, or a metal matrix fiber reinforced composite material. When the rib structural system is made of a lightweight metallic material, the optical fiber including the plurality of FBG members are simply stick into the rib structural system with an adhesive or the like.

As previously mentioned, according to the present invention, the rib structural system is constructed of a grid having a number of polygonal rib units which are continuously arranged, an FBG optical fiber in which a plurality of FBG sensors are arranged at locations dependent upon their reflection wavelengths being layered in the plurality of rib units. When connected with external diagnostic equipment, the rib structural system makes it possible to easily carry out a diagnosis of the soundness of a structure to which the rib structural system is attached, such as a diagnosis of which parts of the rib structural system have strains or influence of temperature changes, with a high degree of accuracy.

Since the rib structural system according to this embodiment is constructed of a stack of laminated prepregs each of which is made of a fiber reinforced composite material, even if a part of the rib structural system becomes damaged, the damage will never spread over the whole of the rib structural system at once. Therefore, the rib structural system can be reduced in weight and the reliability of the rib structural system can be improved, and hence the rib structural system can be applied to a structure such as space equipment like an artificial satellite, or an aircraft.

When monitoring a structural material, there are provided six degrees of freedom (x, y, z, xy, yz, and zx). In general, there is a necessity to arrange six sensors in order to monitor all the six degrees of freedom. However, the rib structural system according to the present invention makes it possible to reduce the number of required sensors by arranging each sensor midway between any two adjacent intersections in each of which two or more ribs intersect in the structural material.

### Embodiment 2

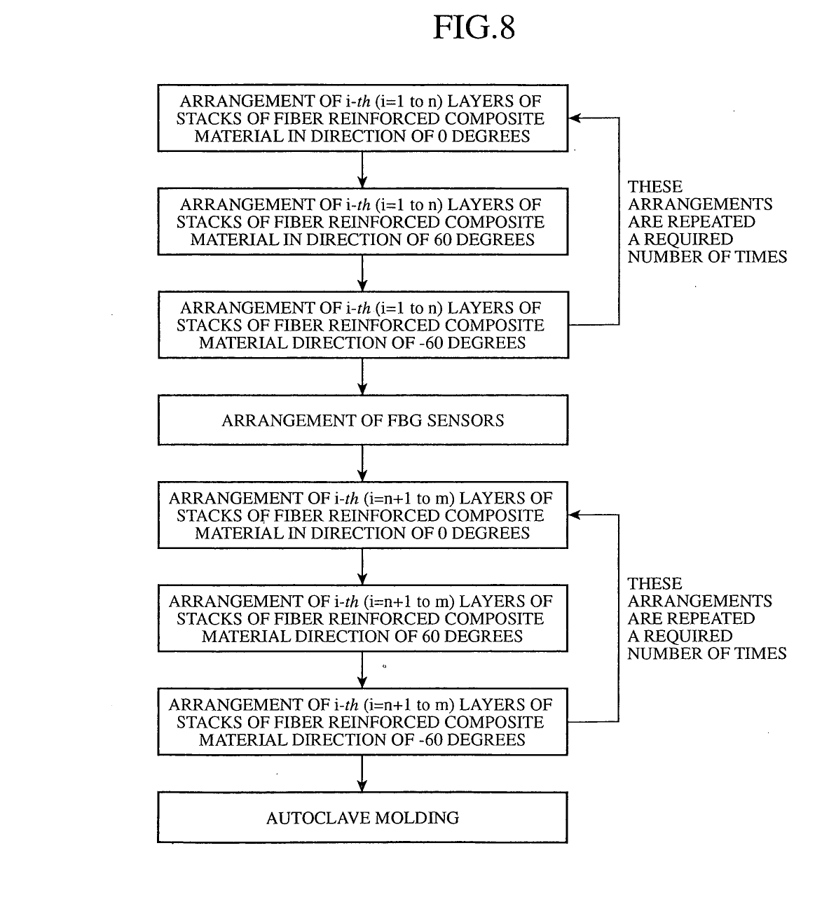

FIG. 8 is a diagram showing a method of manufacturing a rib structural system in which an optical fiber having a plurality of FBG sensors is layered. According to this manufacture method of this embodiment, a rib structural system which consists of a plurality of triangular units or ribs as shown in FIG. 1 is manufactured.

The i-th (i=1 to n, e.g., i=1 in the initial state) layers (i.e., prepregs) of a plurality of parallel stacks are arranged in a direction of 0 degrees, each of the i-th layers being made of tape-shaped fiber reinforced composite material into which a resin is impregnated as a rib material. Then, the i-th (i=1 to n, e.g., i=1 in the initial state) layers of a plurality of parallel stacks are arranged in a direction of 60 degrees, each of the i-th layers being made of tape-shaped fiber reinforced composite material into which a resin is impregnated as a rib material. Next, the i-th (i=1 to n, e.g., i=1 in the initial state) layers of a plurality of parallel stacks re arranged in a direction of −60 degrees, each of the i-th layers being made of tape-shaped fiber reinforced composite material into which a resin is impregnated as a rib material. After that, these arrangement processings for the directions of 0, 60, and −60 degrees are repeated a predetermined number of times until the number of layers contained in a lower layer portion of the rib structural system becomes a desired one determined by the thickness of the plurality of ribs contained in the rib structural system. Then, an optical fiber is routed so that each of the plurality of FGB sensors 4 contained in the optical fiber is located substantially midway between two adjacent intersections in each of which two or more ribs intersect, i.e., between two adjacent points where one stack of layers arranged in the direction of 0 degrees, one stack of layers arranged in the direction of 60 degrees, and one stack of layers arranged in the direction of −60 degrees intersect. After the arrangement of the plurality of FBG sensors and the routing of the optical fiber are completed, a remaining upper layer portion of the rib structural system is formed. In other words, the above-mentioned arrangement processings for the directions of 0, 60, and −60 degrees are repeated a predetermined number of times until the number of layers contained in the upper layer portion of the rib structural system becomes a desired one determined by the thickness of the plurality of ribs contained in the rib structural system. After that, the rib structural system is heat-molded by using an autoclave.

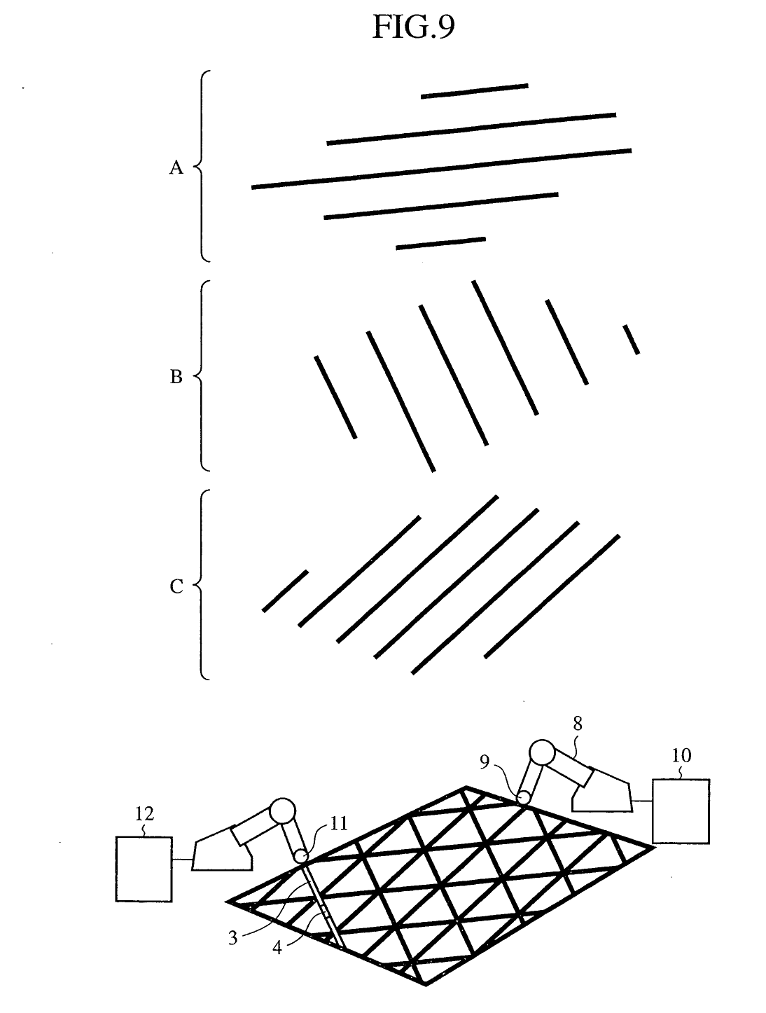

FIG. 9 is a diagram for concretely explaining the manufacturing method. In the figure, A shows a group of tape-shaped prepregs arranged, as the i-th layers, parallel in the direction of 0 degrees, and B shows a group of tape-shaped prepregs arranged, as the i-th layers, parallel in the direction of 60 degrees, and B shows a group of tape-shaped prepregs arranged, as the i-th layers, parallel in the direction of 60 degrees. By using a pressurizing arm head placed at the head of a robot arm 8 controlled by a fiber stack layer forming device control unit 10, the i-th (i>=2) layers of the plurality of parallel stacks are arranged in the directions of 0, 60, and −60 degrees while those layers are pushed down toward their lower layers, respectively. The thickness of the plurality of ribs is decided by the number of times which the further layers of the plurality of parallel stacks are arranged in the directions of 0, 60, and −60 degrees. After that, by using a mounting head 11, an optical fiber 3 is routed so that each of a plurality of FGB sensors 4 contained in the optical fiber 3 is located substantially midway between two adjacent intersections in each of which two or more ribs intersect. The mounting head 11 thus performs the routing of the optical fiber 3 under control of a control unit 12. After the routing of the optical fiber 3 is completed, the arrangement process of arranging a further group of tape-shaped prepregs (A of FIG. 9) in the direction of 0 degrees, the arrangement process of arranging a further group of tape-shaped prepregs (B of FIG. 9) in the direction of 60 degrees, and the arrangement process of arranging a further group of tape-shaped prepregs (C of FIG. 9) in the direction of −60 degrees are repeated until a desired number of layers are formed as the upper layer portion of the rib structural system. After that, the plurality of stacks of prepregs arranged in the form of a grid is heat-molded in the autoclave heat forming step of FIG. 8. As a result, the rib structural system in the form of a grid in which the plurality of FBG sensors are embedded can be manufactured.

Thus, an optical fiber containing a plurality of FBG sensors is layered in the plurality of ribs according to the procedure of laminating a plurality of prepregs each made of a fiber reinforced composite material into which a resin is impregnated. Therefore, the present embodiment offers an advantage of being able to automatically form the rib structural system in which an optical fiber containing a plurality of FBG sensors is integrally layered. In addition, the method according to this embodiment can manufacture the rib structural system of high reliability at a low cost and in a short time, and excels in manufacturability.

### Embodiment 3

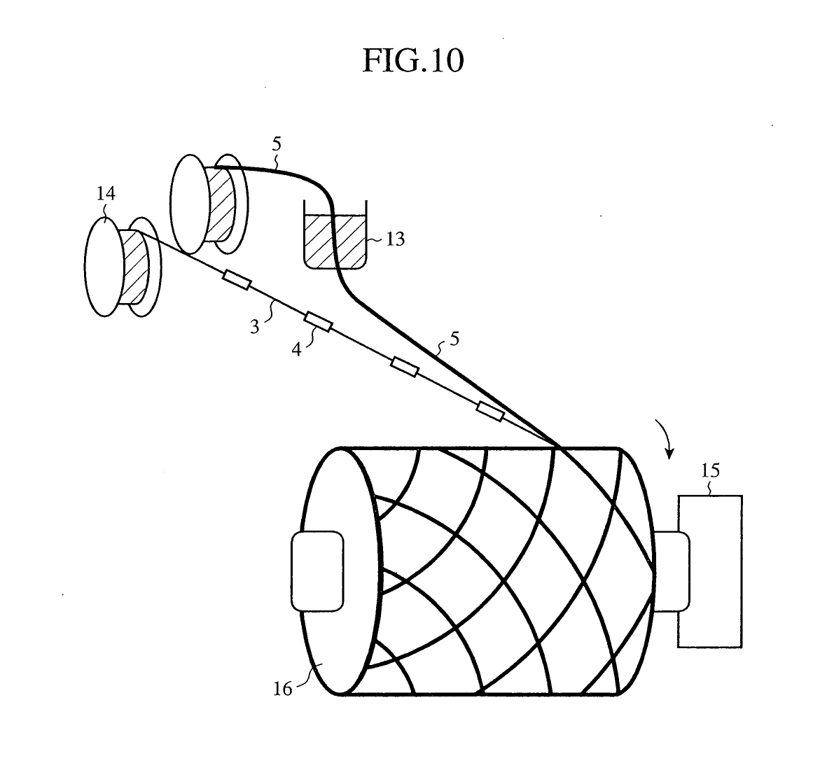

FIG. 10 is a diagram showing a method of manufacturing a cylindrical grid-shaped rib structural system by using a filament winding (FW) method, the rib structural system containing an optical fiber having a plurality of FBG sensors which is layered therein.

A fiber reinforced composite material 5 is made to pass through an impregnating tank 13 containing a resin, is impregnated with the resin, is wound around a forming block 16 which is rotated by a control apparatus 15, and is laminated in the form of a grid, so that a lower layer portion the cylindrical grid-shaped rib structural system is formed. When the lower layer portion has a required number of laminated layers, an optical fiber 3 having a plurality of FBG sensors 4 is fed to the forming block from an optical fiber feeding unit 14 so that the optical fiber 3 is arranged on the lower layer portion already formed on the forming block 16. At this time, each of the plurality of FBG sensors 4 is arranged at a location dependent upon the reflection wavelength thereof so that each of the plurality of FBG sensors 4 is located substantially midway between two adjacent intersections in each of which two or more ribs 2 intersect.

After that, the fiber reinforced composite material 5, which is made to pass through the impregnating tank 13 and is impregnated with the resin, is further wound around the forming block 16 which is rotated by the control apparatus 15, and is laminated until a required number of layers are further formed, so that an upper layer portion of the cylindrical grid-shaped rib structural system is formed.

Thus, during the process of impregnating the fiber reinforced composite material 5 with resin, and laminating the fiber reinforced composite material 5 on the forming block, an optical fiber containing a plurality of FBG sensors is layered in the laminated fiber reinforced composite materials. Therefore, according to the manufacturing method of this embodiment, a lightweight rib structural system of high reliability which can monitor the soundness of a structure more easily can be manufactured. In addition, since the method according to this embodiment uses the FW method of integrally forming rib structural systems, the method according to this embodiment can manufacture the rib structural system of high reliability at a low cost and in a short time, and excels in manufacturability.

Many widely different embodiments of the present invention may be constructed without departing from the spirit and scope of the present invention. It should be understood that the present invention is not limited to the specific embodiments described in the specification, except as defined in the appended claims.

1. A rib structural system comprising:
a grid including a plurality of intersecting ribs; and
an optical fiber including a plurality of Fiber Bragg Grating members having at least two reflection wavelengths, each of said plurality of Fiber Bragg Grating members being located substantially midway between adjacent intersections of said grid where at least two of said plurality of ribs intersect.

2. The rib structural system according to claim 1, wherein each of said plurality of ribs includes a laminated member that is a stack of layers, each layer including a fiber reinforced composite material, a part of said optical fiber in which said plurality of Fiber Bragg Grating members are located being layered in said laminated member.

3. The rib structural system according to claim 1, wherein said rib structural system has a three-dimensional structure.

4. A method of manufacturing a rib structural system, comprising:
laminating first prepregs, each first prepreg including a tape-shaped fiber reinforced composite material and pressurizing said first prepregs to form a lower layer portion of said rib structural system;
placing an optical fiber including a plurality of Fiber Bragg Grating members on said lower layer portion so that said plurality of Fiber Bragg Grating members are arranged at locations dependent upon their reflection wavelengths; and
laminating second prepregs each second prepreg including a tape-shaped fiber reinforced composite material, on said optical fiber and pressurizing said prepregs.

5. A method of manufacturing a rib structural system, comprising:
impregnating a fiber reinforced composite material with a resin and winding said fiber reinforced composite material around a forming block to form a lower layer portion of said rib structural system;
placing an optical fiber including a plurality of Fiber Bragg Grating members on said lower layer portion so that said plurality of Fiber Bragg Grating members are arranged at locations dependent upon their reflection wavelengths; and
laminating said fiber reinforced composite material into which the resin is impregnated on said optical fiber in which said plurality of Fiber Bragg Grating members are arranged, and winding said fiber reinforced composite material around said forming block.
